(19) United States
(12) Patent Application Publication
(10) Pub. No.: US 2020/0394299 A1
(43) Pub. Date: Dec. 17, 2020

(54) ADAPTIVE DYNAMIC MALWARE ANALYSIS ENVIRONMENT

(71) Applicant: National Technology & Engineering Solutions of Sandia, LLC, Albuquerque, NM (US)

(72) Inventors: Vincent Urias, Albuquerque, NM (US); Caleb Loverro, Albuquerque, NM (US); David Jakob Fritz, Fort Collins, CO (US); Richard James Strong, Albuquerque, NM (US)

(21) Appl. No.: 16/902,345

(22) Filed: Jun. 16, 2020

Related U.S. Application Data
(60) Provisional application No. 62/862,527, filed on Jun. 17, 2019.

(51) Int. Cl. G06F 21/56; G06F 9/455; G06F 21/53

(52) U.S. Cl. CPC G06F 21/562; G06F 9/45558; G06F 21/53; G06F 2221/033; G06F 2009/45591; G06F 2221/2119; G06F 2009/45562

(57) ABSTRACT

A computer-implemented method of analyzing malware is provided. The method comprises creating a number of virtual machines that simulate environments and running a number of malware programs on the virtual machines. A hypervisor performs virtual machine introspection as the malware programs run on the virtual machines, wherein the virtual machines and malware programs are unaware the virtual machine introspection is being performed. Behavioral data about the malware programs is collected and presented to a user via an interface.

### CROSS-REFERENCE TO RELATED APPLICATION

This application claims the benefit of U.S. Provisional Application No. 62/862,527 filed Jun. 17, 2019, which is incorporated herein by reference.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The disclosure relates generally to computer security, and more specifically to analysis of malware behavior.

### 2. Description of the Related Art

Malware, generally speaking, is any software designed to cause damage to a computer system or network. Malware does the damage after it is introduced in some way into a target computer and can take several forms such as, executable code, scripts, active content, etc.

One strategy for protecting against malware is to prevent the malware gaining access to the target computer, in addition to checking for the presence of malware and malicious activity and recovering from attacks. However, effective defense against malware requires a thorough understanding of its capabilities and behaviors. This process is hampered by the presence of “packed” binary in which an executable file is compress and combined with decompression code in a single executable.

At execution time, the packed malware is loaded into memory and the unpacker program jumps to the address and executes the malicious payload. This process can be repeated by extracting additional portions of packed code during the lifetime of a process. As long as a malware remains unpacked, it cannot be properly analyzed or often even detected.

Therefore, it would be desirable to have a method and apparatus that take into account at least some of the issues discussed above, as well as other possible issues.

### SUMMARY

An illustrative embodiment provides computer-implemented method of analyzing malware. The method comprises creating a number of virtual machines that simulate a number of computing environments and running a number of malware programs on the virtual machines. A hypervisor performs virtual machine introspection as the malware programs run on the virtual machines, wherein the virtual machines and malware programs are unaware the virtual machine introspection is being performed. Behavioral data about the malware programs is collected and presented to a user via an interface.

Another illustrative embodiment provides a computer program product for analyzing malware. The computer program product comprises a computer-readable storage medium having program instructions embodied thereon to perform the steps of: creating a number of virtual machines that simulate a number of computing environments; running a number malware programs on the virtual machines; performing virtual machine introspection using a hypervisor as the malware programs run on the virtual machines, wherein the virtual machines and malware programs are unaware the virtual machine introspection is being performed; collecting behavioral data about the malware programs; and presenting the collected behavioral data to a user via an interface.

Another illustrative embodiment provides a system for analyzing malware. The system comprises a bus system; a storage device connected to the bus system, wherein the storage device stores program instructions; and a number of processors connected to the bus system, wherein the number of processors execute the program instructions to: create a number of virtual machines that simulate a number of computing environments; run a number of malware programs on the virtual machines; perform virtual machine introspection using a hypervisor as the malware programs run on the virtual machines, wherein the virtual machines and malware programs are unaware the virtual machine introspection is being performed; collect behavioral data about the malware programs; and present the collected behavioral data to a user via an interface.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 depicts a block diagram of a malware analysis system in accordance with illustrative embodiments;

FIG. 3 depicts a block diagram of a virtual machine introspection system in accordance with illustrative embodiments;

FIG. 4 depicts a system for conducting concurrent VMI experiments in accordance with illustrative embodiments;

FIG. 5 depicts a process of discovering artifacts in malware in accordance with illustrative embodiments;

FIG. 6 depicts a flowchart for virtual machine introspection in accordance with illustrative embodiments;

FIG. 7 depicts a flowchart for deep virtual machine introspection in accordance with illustrative embodiments;

FIG. 8 depicts a flowchart for discovering packed malware code in accordance with illustrative embodiments;

FIG. 9 depicts a flowchart for misleading malware code in accordance with illustrative embodiments; and

FIG. 10 is a diagram of a data processing system depicted in accordance with an illustrative embodiment.

### DETAILED DESCRIPTION

The illustrative embodiments recognize and take into account one or more different considerations. For example, the illustrative embodiments recognize and take into account that unpacked malware binary is difficult to analyze and detect through static analysis.

The illustrative embodiments provide an adaptive malware analysis environment that serves as a flexible tool for performing automated, behavioral malware analysis. Users can submit malware samples, which are then executed in a set of diverse virtualized environments while behavioral data is collected. Analytic pipelines allow the aggregation of behavioral data and provided to the user for analysis via a user interface. By giving the malware free run of an isolated, virtual environment over which the user has complete ownership, the illustrative embodiments enable a transparent view of what the malware is doing as it executes.

The illustrative embodiments provide the ability to create a specific custom operating system (environment) to assess if the malware will execute on specific versions of operating systems, software, etc. This simulated, custom environment can emulate an entire enterprise of applications for malware to interact with and for network defenders to gather information about the malware.

The illustrative embodiments provide a suite of analytics for both machine learning and behavior to determine if software is malicious and map the activities to common adversary tactics and techniques based on real-world observations (such as, e.g., as the MITRE ATT&CK framework). Embodiments can fuse open source information sources such as DNS to create realistic responses in the environment to trigger malware.

The dynamic provisioning of an OS-plus-application system allows users to create their own target environments in an automated fashion and pull unpacked binaries from memory to expedite the malware reverse engineering processes.

Embodiments support scalability and are hardware independent. Illustrative embodiments can scale to 1000-2000 virtual machines (VM) per physical server. Algorithms can be provided to age the system to provide a lived-in feel for the malware.

Embodiments dynamically detect filetype information and actuate the application (such as, e.g., Word, url browsing, etc.) in an agentless fashion. Virtual machine introspection (VMI) provides information in an OS-independent fashion about the execution of the malware.

The illustrative embodiments support both the creation of static, dynamic, and application scanning in an automated fashion. The platform can scale from a single host to thousands of hosts to execute up to millions of samples a day. The embodiments have the ability to extract the full operating system state (libraries, symbols, etc.) from the guest and import them into static analysis tools such as, e.g., IDA Pro. They can also extract file traces from all binary content and urls from the all emails and run them through dynamic analysis. Embodiments can support the development of malware similarity and indicators of malicious behavior, run yara signatures on the dynamic analysis traces, and develop yara signatures from the runs in a dynamic fashion.

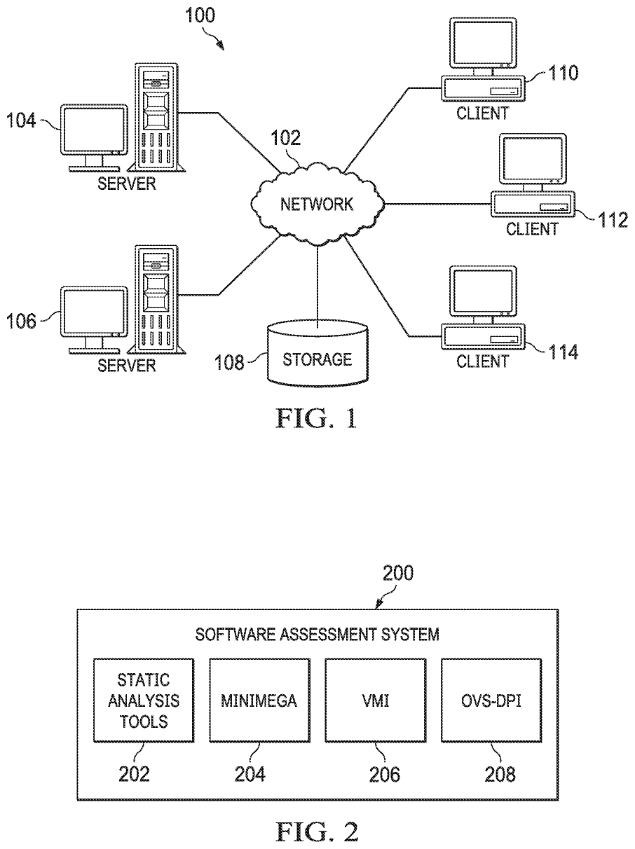

With reference now to the figures and, in particular, with reference to FIG. 1, an illustration of a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, a programmable apparatus, or other device to produce a computer implemented process, such that the instructions which execute on the computer, the programmable apparatus, or the other device implement the functions and/or acts specified in the flowchart and/or block diagram block or blocks.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is a medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers include client computer 110, client computer 112, and client computer 114. Client computer 110, client computer 112, and client computer 114 connect to network 102. These connections can be wireless or wired connections depending on the implementation. Client computer 110, client computer 112, and client computer 114 may be, for example, personal computers or network computers. In the depicted example, server computer 104 provides information, such as boot files, operating system images, and applications to client computer 110, client computer 112, and client computer 114. Client computer 110, client computer 112, and client computer 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, the program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

The illustration of network data processing system 100 is not meant to limit the manner in which other illustrative embodiments can be implemented. For example, other client computers may be used in addition to or in place of client computer 110, client computer 112, and client computer 114 as depicted in FIG. 1. For example, client computer 110, client computer 112, and client computer 114 may include a tablet computer, a laptop computer, a bus with a vehicle computer, and other suitable types of clients.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

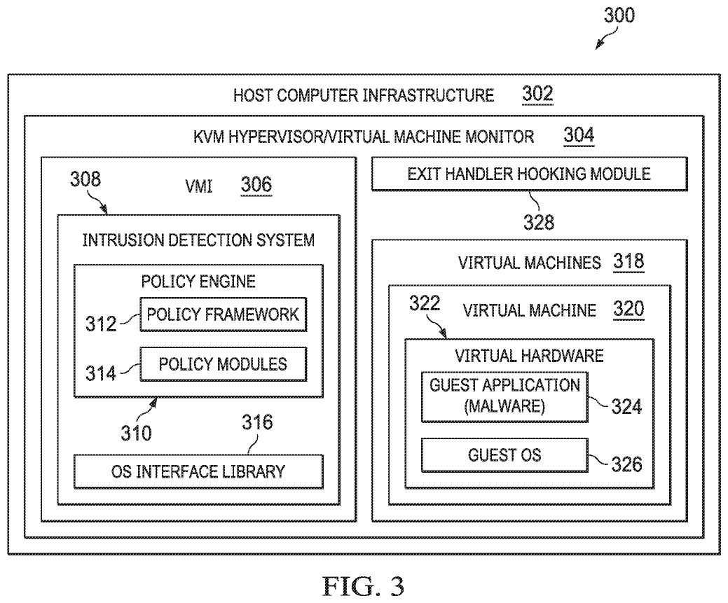

FIG. 2 depicts a block diagram of a malware analysis system in accordance with illustrative embodiments. Malware analysis system 200 can be used to implement using one or more server and client computer system in FIG. 1. The malware analysis system 200 integrates a number of tools to allow both static and dynamic analysis of malware. Static analysis tools 202 permit analysis of the current state of code and make assertions without having to execute the code.

Minimega 204 is a tool for launching and managing virtual machines (VMs). It can launch and manage VM-based experiments and set up complex virtual network topologies in a repeatable manner, and it can integrate real hardware with virtual experiments.

Virtual Machine Introspection (VMI) 206 monitors the runtime state of a virtual machine. VMI 206 tracks events such as interrupts, memory writes, etc., or sends requests to the VM. VMI can be used for forensic analysis of software by providing insight into what is happening inside a host VM while guest software is running on it.

Open vSwitch and deep packet inspection (OVD-DPI) 208 facilitate network and host introspection. OVS provides a software implemented, multi-layer network switch running within a VM hypervisor. DPI inspects data packets sent over a computer network to ensure it is in the correct format, and to check for malicious code and other illicit activity. OVS-DPI 208 provides metadata extraction and over 1200 protocols for classification. OVS-DPI 208 can be fused with VMI data to produce new analytics.

FIG. 3 depicts a block diagram of a virtual machine introspection system in accordance with illustrative embodiments. System 300 comprises a host computer infrastructure 302 on which VMs 318 and VMI 306 run. VMI 306 is an example of VMI 206 in FIG. 2. The host computer infrastructure 302 is able to host a number of VMs 318. In an embodiment, up to 2000 VMs can be hosted on a single physical server. Each VM 320 among the number of VMs 318 comprises virtual hardware 322 on which run a guest operating system (OS) 326 and a guest application 324. In the illustrative embodiments, the guest application 324 is sample malware that is being analyzed.

VMI system 306 comprises an intrusion detection system (IDS) 308, which analyzes the states and events of the VMs 318 through the hypervisor/virtual machine monitor (VMM) 304. The IDS 308 comprises a policy engine 310 and an OS library interface 316. The policy engine 310 comprises a framework 312 for building policies and policy modules 314 that implement specific intrusion detection policies. The OS interface library 316 provides an OS-level view of a VM 320 by interpreting the hardware state exported by the VMM 304. The function of the policy engine 310 is to execute policies of the IDS 308 by using the OS interface library 316 and interface with the VMM 304.

The VMM 304 isolates the guest malware 324 running in a VM 320 and can access VM states such as CPU state (e.g., registers), memory, input/output (I/O) device state simulated in the virtual hardware 322. Isolation prevents the malware 324 from tampering with the IDS 308. Because the VMM 304 can directly inspect a VM 320, it is difficult for intruder code to evade the IDS 308 since there is no state in the monitored VM 320 that the IDS 308 cannot see.

When VMI 306 is running, useful data is immediately captured from a running guest OS 326. This data includes all system calls with parameters (syscalls), which enables the watching of all file creates/reads/writes, socket creation, API functions (e.g., NtWriteVirtualMemory), registry key access/read/write, etc. VMI 306 can read guest OS memory while allowing the user to see and retain copies of all running processes (regardless if the guest 324 sees them or not) and all libraries loaded into memory, including drivers. VMI 306 does not require predetermined knowledge of the guest OS 326 to provide guest OS build details, symbols, or system.map.

Typical VMI provides effective tools for network monitoring such as secure socket layer (SSL) interception and packet capture (PCAP)/DPI. However, it often lacks understanding of what is happening on the guest VM, which is treated as a forensics operation. Often the context is lost, introspection is not in real-time, and the introspection is a “read-only” type of access.

The illustrative embodiments employ a kernel virtual machine (KVM) for the hypervisor/VMM 304. A KVM is a virtualization module in an OS kernel that allows the kernel to function as a hypervisor. By using a KVM for the hypervisor/VMM 304, the illustrative embodiments are able to introspect and understand the dynamic behavior of the VMs 318 without introducing artifacts into a running system, such that a virtual machine 320 and guest application 324 are unaware the introspection is being performed, as well as to control the VM 320 and make changes to it.

Normally, the VMs 318 will run until something causes them to VM-exit, which passes control to the hypervisor/VMM 304 and allows it to view and/or modify their state. In the illustrative embodiments, a kernel module 328 hooks the VM-exit handler of the KVM hypervisor/VMM 304 to gain complete control over guest VMs 318 before the KVM 304 knows the VMs 318 have exited. Hooking the exit handler allows VMI 306 to effectively “be” the hypervisor 304, i.e. kernel virtual machine introspection (KVMI). At a low level of granularity, maximum control includes hypervisor-level execution during every VM-exit, reading or writing any VM state desired by the user, and modifying the hypervisor configuration/state, e.g., to enable or disable hardware virtualization features or force future exits with various tricks.

Therefore, whereas prior method of VMI perform introspection with a VMI system working through a hypervisor, the illustrative embodiments perform the introspection using the hypervisor itself.

The OS capabilities of the illustrative embodiments include, e.g., raw system calls, decoded system calls, process identification number (PID) extraction, guest execution, kernel carving, process carving, process tracking (i.e. start and stop), file extraction, biometrics, socket chardev, VM aging, and guest/host file transfer.

Open source information sources such as, e.g., domain name system (DNS) can be used to create realistic responses in the simulated environment to trigger malware. The KVMI of the illustrative embodiments also have the ability to provide false responses to malware survey techniques such as VM detection and the type of hypervisor. Given guest memory, KVMI can use SSL keys to decrypt traffic in real-time, perform secure shell (SSH) decryption in real-time, and perform encrypted file interception in real-time.

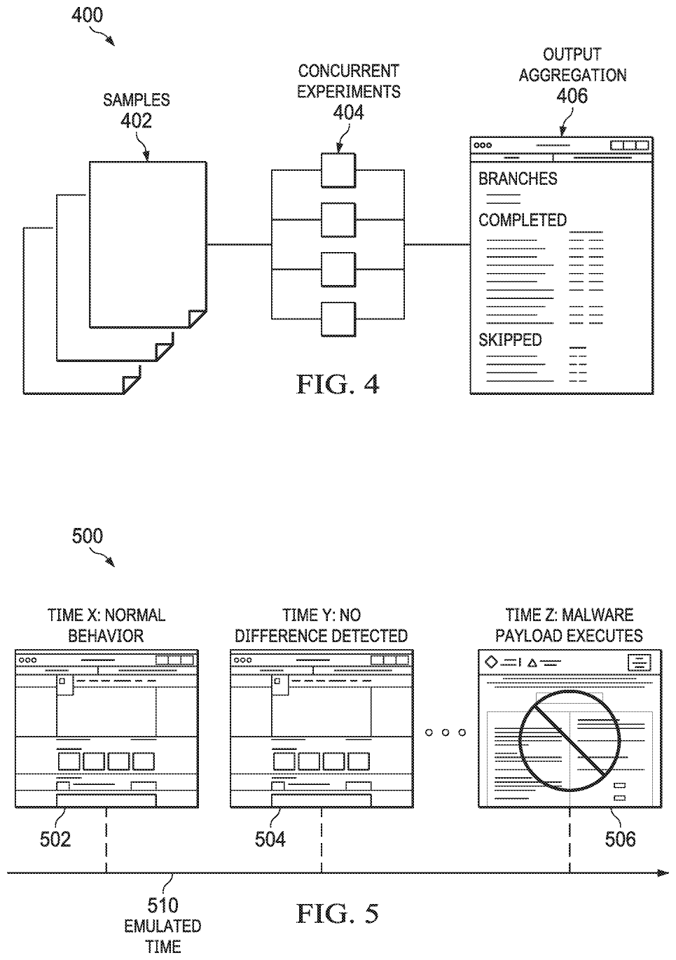

FIG. 4 depicts a system for conducting concurrent VMI experiments in accordance with illustrative embodiments. By leveraging the ability of minimega, emulytics system 400 provides the ability to conduct multiple concurrent experiments 404 on a number of malware samples 402.

Concurrent experiments 404 might comprise alternate VM configurations running the same malware. Alternatively, the VM configuration can be held as a control, and alternate malware versions can be run concurrently in multiple copies of that configuration. Templates can be used to drive any number of concurrent experiments.

Output aggregation 406 allows telemetry data to be compared between alternated malware versions and/or alternate VM system configurations.

FIG. 5 depicts a process of discovering artifacts in malware in accordance with illustrative embodiments. Process 500 provides analysis of a program state at different times during execution to discover time-based anomalies. In the example shown in FIG. 5, at Time X 502 the guest system running on a VM exhibits normal behavior. At Time Y 504 no difference is detected as the guest system continues to run normally. However, at Time Z 506 a malware payload executes. The emulated timeline 510 allows the differential between different experimental runs (such as concurrent runs 404 in FIG. 4) and execution times to be seen in one view. This enable cross correlation across variable such as, e.g., IP space and time. Custom variables can be introduced by the analyst and the job then rerun across all variables.

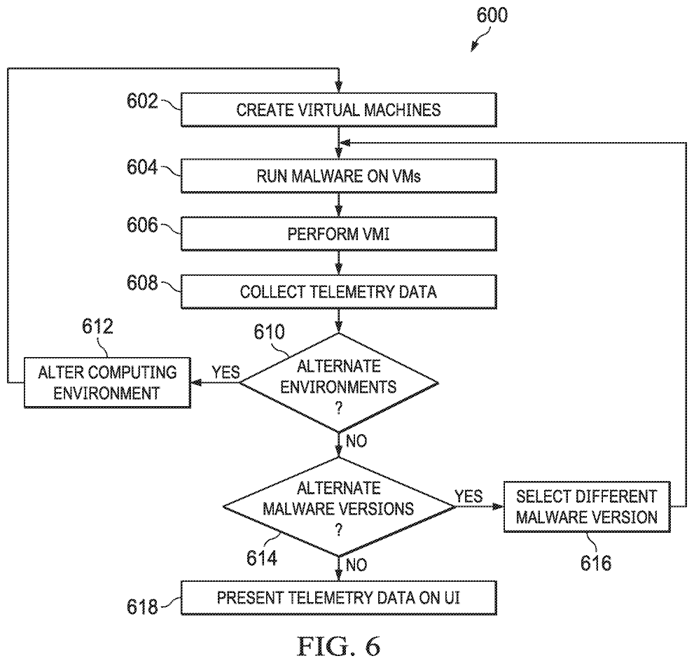

FIG. 6 depicts a flowchart for virtual machine introspection in accordance with illustrative embodiments. Process 600 can be implemented using data processing systems such as those depicted in FIGS. 1-3. Process 600 begins by creating a number of VMs that simulate a number of specified computing environments (step 602). The VMs might emulate a host and network environment.

A number of malware programs are then run on the VMs (step 604). Illustrative embodiments dynamically run the malware on a set of OS, service packs, and software versions to determine any sensitivities in the malware execution to discover malware specific environmental triggers. The malware programs have full access to the simulated computing environments in the VMs. By giving the malware free run of an isolated, virtual environment over which the user has complete ownership, the illustrative embodiments enable a transparent view of what the malware is doing as it executes.

As the malware programs run on the VMs, the host system performs virtual machine introspection using a hypervisor (step 606). Because of the VM-exit handler hooking described above, the VMs and guest malware programs are unaware that the virtual machine introspection is being performed. The VMI collects telemetry data about the malware programs (step 608).

Process 600 also comprises determining if there are alternate computing environments that can be simulated (step 610). If there are alternate computing environments to simulate, the VMI alters the computing environments simulated by the VMs to provoke changes in execution states of the malware programs (step 612). Execution behaviors of the malware programs can then be mapped to specific computing environments.

Malware behavior can be systematically analyzed through dynamic and retroactive provision of new environments based on observables from a prior run to draw unpacked binary into the open. For example, if a binary is looking for a specific service (such as FTP at an IP/DNS location), the illustrative embodiments can automatically spin up an environment that has those attributes to rerun the malware to gain improved analytics about what the malware is doing. As another example, if a binary is looking for a specific version of software (e.g., observed through registry reads, file system activity, etc.) the illustrative embodiments can dynamically create such an environment and resubmit the malware.

Machine learning techniques can be used to detect and classify malware through system call analysis. For example, a convolutional neural network (CNN) might be used to classify code as “goodware” or malware. The input to the CNN might comprise an N-gram, which is a contiguous sequence of N items from a given sample of text such as a system call. The SoftMax function comprising the final layer of the CNN produces an output classifying the source of the system call as goodware or malware according to the similarity of its behavior to know malware used to train the CNN.

It should be noted that VMI for alternate computing environments can also be run concurrently, as explained above in reference to FIG. 4.

The VMI then determines if there are alternate versions of the malware (step 614). If there are different versions, the VMI selects and runs the alternate versions of the malware on the VMs and compares telemetry data for the different versions of the software programs (step 616). The VMI can execute a singleton algorithm for a number of different malware programs and determine similarities in execution among the malware programs. As with alternate computing environments in step 612, the malware versions can be run concurrently on a number of VMs.

Telemetry data collected by the VMI is presented to the user through a UI (step 618). In an embodiment, the UI visually represents relationships among different malware programs according to DNS, similarity of execution, and similarity of static analysis.

In an embodiment, instead of loading known malware programs on the VMs process 600 might comprise visiting a number of websites with the virtual machines and analyzing the websites for malicious activity.

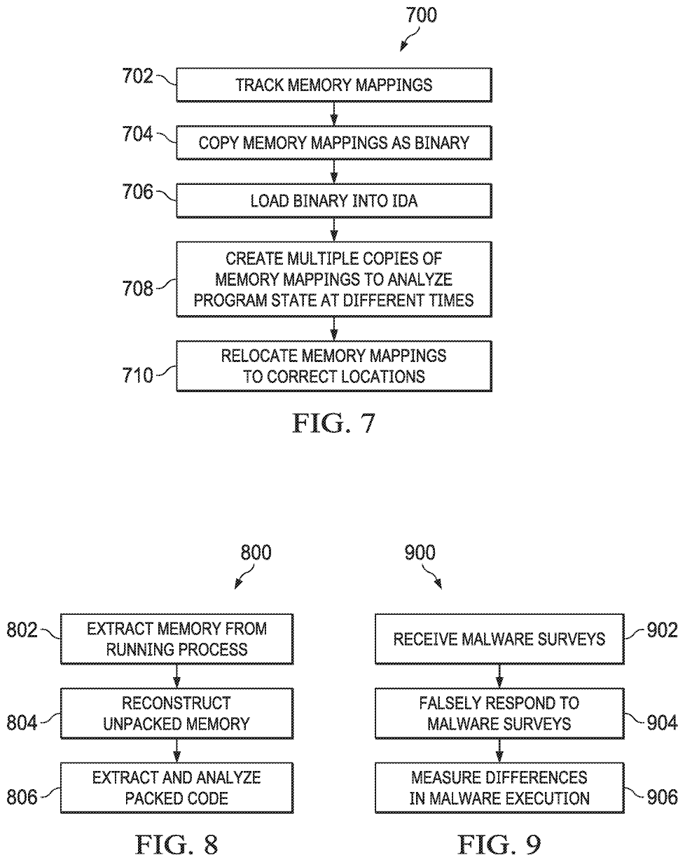

FIG. 7 depicts a flowchart for deep virtual machine introspection in accordance with illustrative embodiments. Process 700 is an extension of VMI step 606 in FIG. 6. The virtual machine introspection further comprises tracking all memory mappings in the virtual machines including libraries and operating system code in addition to the malware (step 702).

The VMI periodically copies the memory mappings as binary (step 704) and loads the binary into an interactive disassembler (IDA) (step 706).

The IDA creates multiple copies of the memory mappings to analyze a program state at different times during execution (step 708). A script (e.g., idapython script) then relocates all memory mappings to correct locations (step 710).

FIG. 8 depicts a flowchart for discovering packed malware code in accordance with illustrative embodiments. Process 800 is an extension of VMI step 606 in FIG. 6.

Process 800 comprises extracting memory from a running process (step 802) and reconstructing unpacked memory in a packer agnostic manner (step 804). Process 800 then extracts and analyzing packed executable code (step 806). Illustrative embodiments are able to extract SSL/TLS/SSH keys from memory and allow decoding of malware command and control (c2) systems and then replay responses to discover c2 control messaging.

FIG. 9 depicts a flowchart for misleading malware code in accordance with illustrative embodiments. Process 900 is an extension of VMI step 606 in FIG. 6. Process 900 comprises receiving malware surveys from the malware program (step 902) and falsely responding to the malware survey techniques (step 904). Algorithms can be used to respond to common VM and Sandbox techniques to falsify system responses so as to encourage execution of the malware. For instance, a common detection mechanism comprises looking for the response of VM CPUIDs. The illustrative embodiments provide the ability to respond as if they are hardware or other hypervisors. By providing false information in response to the surveys, the VMI can measures differences in malware execution produced by the false responses (step 906).

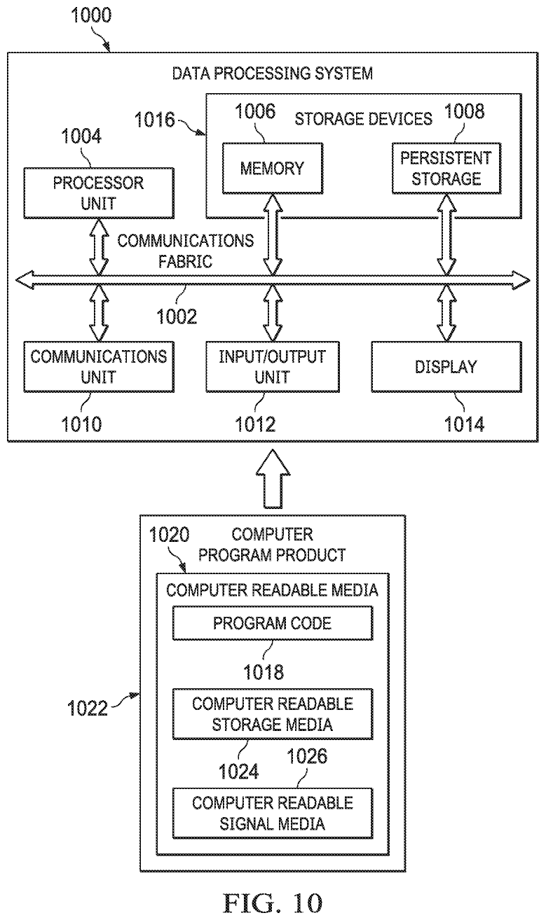

Turning to FIG. 10, a diagram of a data processing system is depicted in accordance with an illustrative embodiment. Data processing system 1000 is an example of a system in which computer-readable program code or program instructions implementing processes of illustrative embodiments may be run. In this illustrative example, data processing system 1000 includes communications fabric 1002, which provides communications between processor unit 1004, memory 1006, persistent storage 1008, communications unit 1010, input/output unit 1012, and display 1014.

Processor unit 1004 serves to execute instructions for software applications and programs that may be loaded into memory 1006. Processor unit 1004 may be a set of one or more hardware processor devices or may be a multi-processor core, depending on the particular implementation. Further, processor unit 1004 may be implemented using one or more heterogeneous processor systems, in which a main processor is present with secondary processors on a single chip. As another illustrative example, processor unit 1004 may be a symmetric multi-processor system containing multiple processors of the same type.

A computer-readable storage device is any piece of hardware that is capable of storing information, such as, for example, without limitation, data, computer-readable program code in functional form, and/or other suitable information either on a transient basis and/or a persistent basis. Further, a computer-readable storage device excludes a propagation medium. Memory 1006, in these examples, may be, for example, a random access memory, or any other suitable volatile or non-volatile storage device. Persistent storage 1008 may take various forms, depending on the particular implementation. For example, persistent storage 1008 may contain one or more devices. For example, persistent storage 1008 may be a hard drive, a flash memory, a rewritable optical disk, a rewritable magnetic tape, or some combination of the above. The media used by persistent storage 1008 may be removable. For example, a removable hard drive may be used for persistent storage 1008.

Communications unit 1010, in this example, provides for communication with other computers, data processing systems, and devices via network communications unit 1010 may provide communications using both physical and wireless communications links. The physical communications link may utilize, for example, a wire, cable, universal serial bus, or any other physical technology to establish a physical communications link for data processing system 1000. The wireless communications link may utilize, for example, shortwave, high frequency, ultra-high frequency, microwave, wireless fidelity (WiFi), Bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 1000.

Input/output unit 1012 allows for the input and output of data with other devices that may be connected to data processing system 1000. For example, input/output unit 1012 may provide a connection for user input through a keypad, keyboard, and/or some other suitable input device. Display 1014 provides a mechanism to display information to a user and may include touch screen capabilities to allow the user to make on-screen selections through user interfaces or input data, for example.

Instructions for the operating system, applications, and/or programs may be located in storage devices 1016, which are in communication with processor unit 1004 through communications fabric 1002. In this illustrative example, the instructions are in a functional form on persistent storage 1008. These instructions may be loaded into memory 1006 for running by processor unit 1004. The processes of the different embodiments may be performed by processor unit 1004 using computer-implemented program instructions, which may be located in a memory, such as memory 1006. These program instructions are referred to as program code, computer-usable program code, or computer-readable program code that may be read and run by a processor in processor unit 1004. The program code, in the different embodiments, may be embodied on different physical computer-readable storage devices, such as memory 1006 or persistent storage 1008.

Program code 1018 is located in a functional form on computer-readable media 1020 that is selectively removable and may be loaded onto or transferred to data processing system 1000 for running by processor unit 1004. Program code 1018 and computer-readable media 1020 form computer program product 1022. In one example, computer-readable media 1020 may be computer-readable storage media 1024 or computer-readable signal media 1026. Computer-readable storage media 1024 may include, for example, an optical or magnetic disc that is inserted or placed into a drive or other device that is part of persistent storage 1008 for transfer onto a storage device, such as a hard drive, that is part of persistent storage 1008. Computer-readable storage media 1024 also may take the form of a persistent storage, such as a hard drive, a thumb drive, or a flash memory that is connected to data processing system 1000. In some instances, computer-readable storage media 1024 may not be removable from data processing system 1000.

Alternatively, program code 1018 may be transferred to data processing system 1000 using computer-readable signal media 1026. Computer-readable signal media 1026 may be, for example, a propagated data signal containing program code 1018. For example, computer-readable signal media 1026 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer-readable media also may take the form of non-tangible media, such as communication links or wireless transmissions containing the program code.

In some illustrative embodiments, program code 1018 may be downloaded over a network to persistent storage 1008 from another device or data processing system through computer-readable signal media 1026 for use within data processing system 1000. For instance, program code stored in a computer-readable storage media in a data processing system may be downloaded over a network from the data processing system to data processing system 1000. The data processing system providing program code 1018 may be a server computer, a client computer, or some other device capable of storing and transmitting program code 1018.

The different components illustrated for data processing system 1000 are not meant to provide architectural limitations to the manner in which different embodiments may be implemented. The different illustrative embodiments may be implemented in a data processing system including components in addition to, or in place of, those illustrated for data processing system 1000. Other components shown in FIG. 10 can be varied from the illustrative examples shown. The different embodiments may be implemented using any hardware device or system capable of executing program code. As one example, data processing system 1000 may include organic components integrated with inorganic components and/or may be comprised entirely of organic components excluding a human being. For example, a storage device may be comprised of an organic semiconductor.

As another example, a computer-readable storage device in data processing system 1000 is any hardware apparatus that may store data. Memory 1006, persistent storage 1008, and computer-readable storage media 1024 are examples of physical storage devices in a tangible form.

In another example, a bus system may be used to implement communications fabric 1002 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 1006 or a cache such as found in an interface and memory controller hub that may be present in communications fabric 1002.

The present invention may be a system, a method, and/or a computer program product. The computer program product may include a computer-readable storage medium or media having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer readable program instructions to personalize the electronic circuitry, in order to perform aspects of the present invention.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method of analyzing malware, the method comprising:
creating, by a number of processors, a number of virtual machines that simulate a number of computing environments;
running, by a number of processors, a number of malware programs on the virtual machines;
performing, by a number of processors, virtual machine introspection using a hypervisor as the malware programs run on the virtual machines, wherein the virtual machines and malware programs are unaware the virtual machine introspection is being performed;
collecting, by a number of processors, behavioral data about the malware programs; and
presenting, by a number of processors, the collected behavioral data to a user via an interface.

2. The method of claim 1, wherein the virtual machine introspection further comprises tracking all memory mappings in the virtual machines including libraries, operating system code, and malware program code.

3. The method of claim 2, further comprising:
periodically copying the memory mappings as binary; and
loading the binary into an interactive disassembler.

4. The method of claim 3, further comprising creating multiple copies of the memory mappings to analyze a program state at different times during execution.

5. The method of claim 1, further comprising:
altering the computing environments simulated by the virtual machines to provoke changes in execution states of the malware programs; and
mapping execution behaviors of the malware programs to specific computing environments.

6. The method of claim 1, further comprising:
extracting memory from a running process;
reconstructing unpacked memory in a packer agnostic manner; and
extracting and analyzing packed executable code.

7. The method of claim 1, further comprising:
receiving malware surveys;
falsely responding to the malware surveys; and
measuring differences in malware execution produced by the false responses.

8. The method of claim 1, further comprising:
executing a singleton algorithm for a number of different malware programs; and
determining similarities in execution among the malware programs.

9. The method of claim 1, wherein the virtual machines emulate a host and network environment.

10. The method of claim 1, further comprising:
visiting a number of websites with the virtual machines; and
analyzing the websites for malicious activity.

11. The method of claim 1, further comprising visually representing relationships among different malware programs according to domain name system, similarity of execution, and similarity of static analysis.

12. A computer program product for analyzing malware, the computer program product comprising:
a computer-readable storage medium having program instructions embodied thereon to perform the steps of:
creating a number of virtual machines that simulate a number of computing environment;
running a number of malware programs on the virtual machines;
performing virtual machine introspection using a hypervisor as the malware programs run on the virtual machines, wherein the virtual machines and malware programs are unaware the virtual machine introspection is being performed;
collecting behavioral data about the malware programs; and
presenting the collected behavioral data to a user via an interface.

13. The computer program product of claim 12, wherein the virtual machine introspection further comprises tracking all memory mappings in the virtual machines including libraries, operating system code, and malware program code.

14. The computer program product of claim 13, further comprising instruction for:
periodically copying the memory mappings as binary; and
loading the binary into an interactive disassembler.

15. The computer program product of claim 14, further comprising instructions for creating multiple copies of the memory mappings to analyze a program state at different times during execution.

16. The computer program product of claim 12, further comprising instructions for:
altering the computing environments simulated by the virtual machines to provoke changes in execution states of the malware programs; and
mapping execution behaviors of the malware programs to specific computing environments.

17. The computer program product of claim 12, further comprising instructions for:
extracting memory from a running process;
reconstructing unpacked memory in a packer agnostic manner; and
extracting and analyzing packed executable code.

18. The computer program product of claim 12, further comprising instructions for:
receiving malware surveys;
falsely responding to malware surveys; and
measuring differences in malware execution produced by the false responses.

19. The computer program product of claim 12, further comprising instructions for:
executing a singleton algorithm for a number of different malware programs; and
determining similarities in execution among the malware programs.

20. The computer program product of claim 12, wherein the virtual machines emulate a host and network environment.

21. The computer program product of claim 12, further comprising instructions for:
visiting a number of websites with the virtual machines; and
analyzing the websites for malicious activity.

22. The computer program product of claim 12, further comprising instructions for visually representing relationships among different malware programs according to domain name system, similarity of execution, and similarity of static analysis.

23. A system for analyzing malware, the system comprising:
a bus system;
a storage device connected to the bus system, wherein the storage device stores program instructions; and
a number of processors connected to the bus system, wherein the number of processors execute the program instructions to:
create a number of virtual machines that simulate a number of computing environments;
run a number of malware programs on the virtual machines;
perform virtual machine introspection using a hypervisor as the malware programs run on the virtual machines, wherein the virtual machines and malware programs are unaware the virtual machine introspection is being performed;
collect behavioral data about the malware programs; and
present the collected behavioral data to a user via an interface.

24. The system of claim 23, wherein the virtual machine introspection further comprises tracking all memory mappings in the virtual machines including libraries, operating system code, and malware program code.

25. The system of claim 24, wherein the number of processors further execute instructions to:
periodically copy the memory mappings as binary; and
load the binary into an interactive disassembler.

26. The system of claim 25, wherein the number of processors further execute instructions to create multiple copies of the memory mappings to analyze a program state at different times during execution.

27. The system of claim 23, wherein the number of processors further execute instructions to:
alter the computing environments simulated by the virtual machines to provoke changes in execution states of the malware programs; and
map execution behaviors of the malware programs to specific computing environments.

28. The system of claim 23, wherein the number of processors further execute instructions to:
extract memory from a running process;
reconstruct unpacked memory in a packer agnostic manner; and
extract and analyze packed executable code.

29. The system of claim 23, wherein the number of processors further execute instructions to:
receive malware surveys;
falsely respond to malware surveys; and
measure differences in malware execution produced by the false responses.

30. The system of claim 23, wherein the number of processors further execute instructions to:
execute a singleton algorithm for a number of different malware programs; and
determine similarities in execution among the malware programs.

31. The system of claim 23, wherein the virtual machines emulate a host and network environment.

32. The system of claim 23, wherein the number of processors further execute instructions to:
visit a number of websites with the virtual machines; and
analyze the websites for malicious activity.

33. The system of claim 23, wherein the number of processors further execute instructions to visually represent relationships among different malware programs according to domain name system, similarity of execution, and similarity of static analysis.
